(19) United States
(12) Patent Application Publication
(10) Pub. No.: US 2026/0059417 A1
(43) Pub. Date: Feb. 26, 2026

(54) CONTROLLING CONFIGURATION ACTIVITIES IN A WIRELESS TELECOMMUNICATIONS NETWORK

(71) Applicant: Nokia Technologies Oy, Espoo (FI)

(72) Inventors: Irina-Mihaela BALAN, Munich (DE); Ahmad AWADA, Munich (DE); Halit Murat GÜRSU, Munich (DE); Srinivasan SELVAGANAPATHY, Bangalore (IN); Umur KARABULUT, Munich (DE)

(21) Appl. No.: 19/100,695

(22) PCT Filed: Jun. 21, 2023
(86) PCT No.: PCT/EP2023/066782

§ 371 Date: Feb. 3, 2025

(30) Foreign Application Priority Data
Aug. 9, 2022 (IN) 202241045425

(51) Int. Cl. H04W 36/36; H04W 36/00

(52) U.S. Cl. CPC H04W 36/362; H04W 36/0069

(57) ABSTRACT

A user equipment of a telecommunications network comprising: at least one processor; and at least one memory storing instructions that, when executed by the at least one processor, cause the user equipment at least to: receive a configuration message from a network node, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

### TECHNOLOGICAL FIELD

Various example embodiments relate to controlling configuration activities in a wireless telecommunications network.

### BACKGROUND

In some wireless telecommunications networks, several mobility mechanisms rely on dual execution events or two separate execution conditions where a user equipment (UE) is expected to start measuring or perform other tasks or activities for all execution conditions it has been configured with as soon as a new configuration is received. Such an approach can lead to an inefficient use of available resources. Accordingly, it is desired to provide an improve technique.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

According to various, but not necessarily all, example embodiments of the invention there is provided a user equipment of a telecommunications network comprising: at least one processor; and at least one memory storing instructions that, when executed by the at least one processor, cause the user equipment at least to: receive a configuration message from a network node, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The configuration message may comprise a measurement configuration message and the activity comprises a measurement activity.

The instructions may cause the user equipment at least to: perform the measurement activity.

The condition may indicate when the measurement activity is to be in an active state where the measurement activity is to be performed by the user equipment or in an inactive state where the measurement activity is not to be performed.

The condition may indicate when the measurement activity is to be in an active state where the measurement activity is to be performed by the user equipment connected to the network or in an inactive state where the measurement activity is not to be performed.

The measurement configuration message may indicate whether the measurement activity is by default in the active state or the inactive state.

The condition may indicate when the measurement activity is to switch between the active state and the inactive state.

The measurement configuration message may provide an indication of a plurality of measurement activities to be performed by the user equipment together with a condition related to the measurement activity.

The measurement configuration message may provide an indication of a plurality of measurement activities to be performed by the user equipment connected to the network node together with a condition related to the measurement activity.

The plurality of measurement activities may comprise a first measurement activity having a first condition and a second measurement activity having a second condition, the second condition evaluation being conditional on an outcome of the first condition.

The second measurement activity may have a third condition, the second condition evaluation being conditional on an outcome of the third condition.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when a degradation in the radio conditions measured by the first measurement activity is detected.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when the radio conditions measured by the first measurement activity are detected.

The first measurement activity may comprise radio link monitoring of at least a serving Primary Serving Cell (PSCell), the second measurement activity may comprise measuring radio conditions of at least one target Primary Cell (PCell) and second measurement activity may be switched to the active state when a radio link failure, T310 activation or beam failure associated with the serving PSCell is detected.

The instructions may cause the user equipment at least to: activate the second measurement activity when a radio link failure, T310 activation or beam failure associated with the serving PSCell is detected.

The user equipment may be configured for dual connectivity with at least the network node comprising a source master node and with a first secondary node and the configuration message may comprise a handover request acknowledgement received from the master node, the handover request acknowledgement indicating a first activity of applying a configuration for connection with a target master node and the first secondary node when an activated first condition of a radio link failure, T310 activation or beam failure associated with a serving PSCell is not detected and the handover request acknowledgement indicating a second activity of applying a configuration for connection with the target master node and a second secondary node when a deactivated second condition is activated, the deactivated second condition being activated when the first condition is false.

The instructions may cause the user equipment at least to: upon detection of the radio link failure, T310 activation or beam failure associated with the serving PSCell, activate the second condition.

The network node may comprise a target master node or a source master node.

When the network node comprises the source master node, the configuration message may comprise a Radio Resource Control (RRC) Reconfiguration message.

When the network node comprises the target master node, the configuration message may comprise a Handover (HO) Request Acknowledgement (Ack) message.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a conditional cell change from the currently serving cell to the target serving cell commences.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a cell change is executed from the currently serving cell to the target serving cell.

The instructions may cause the user equipment at least to: activate the first measurement activity and inactivate the second measurement activity when a cell change is executed from the currently serving cell to the target serving cell.

The user equipment may be configured for dual connectivity with at least the network node comprising a source master node and with a source secondary node and the configuration message may comprise an RRC Reconfiguration message received from the source master node, the RRC Reconfiguration message indicating a first activity of measuring a PSCell of the source secondary node with a first condition of the measuring being deactivated when the user equipment is connected to the source master node, the RRC Reconfiguration message indicating a second activity of measuring a PSCell of the target secondary node with a second condition of the measuring being activated when the user equipment is not connected to the target master node.

The user equipment may be configured in response to executing conditional primary serving cell change towards the target secondary node to activate the first activity of measuring the PSCell of the source secondary node with and deactivate the second activity of measuring the PSCell of the target secondary node.

The measuring may be deactivated by deactivating an associated measurement_ID and activated by activating an associated measurement_ID.

The network node may comprise a source master node.

The configuration message may comprise an RRC Reconfiguration message.

The first measurement activity may comprise measuring radio conditions of a currently serving cell and the second measurement activity may comprise measuring radio conditions of a target serving cell, the first measurement activity may be in the active state by default and the second measurement activity may be in the inactive state by default, the second measurement activity may be switched to the active state when a degradation in the radio conditions measured by the first measurement activity beyond a threshold amount is detected.

The first measurement activity may comprise measuring radio conditions of at least a serving PCell, the second measurement activity may comprise measuring radio conditions of at least a PSCell and the measurement configuration message may provide an indication of a further measurement activity comprising measuring radio conditions of at least a serving PCell and a further condition to be fulfilled prior to switching the second measurement activity to the active state.

The further condition may comprise measuring a received signal power which is lower by an offset amount than the power measured by the first measurement activity which would lead to conditional handover.

The instructions may cause the user equipment at least to: activate the second measurement activity when the received signal power is lower by the offset amount than the power measured by the first measurement activity which would lead to conditional handover.

The instructions may cause the user equipment at least to: activate the second measurement activity when the received signal power is lower by the offset amount than the power measured by the first measurement activity which would lead to conditional handover.

The user equipment may be configured for dual connectivity with at least the network node comprising a source master node and with a first secondary node and the configuration message may comprise a handover request acknowledgement received from the master node, the handover request acknowledgement indicating a first activity of applying a configuration for connection with a target master node when a first activated condition of measured radio conditions require a conditional handover, a deactivated second condition measuring radio conditions of a PSCell and an activated third condition of determining when measured radio conditions are a predetermined amount lower than those requiring a conditional handover, the second condition being activated when the third condition is true.

The predetermined amount may be for example, 2 dB, but also may be a value in the range of for example 1 to 4 dB.

The instructions may cause the user equipment at least to: upon detection the third condition being true, activate the second condition.

The instructions may cause the user equipment at least to: upon detection the first condition being true, determine the PSCell addition associated with the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The measurement activity may be associated with a measurement-ID.

The instructions may cause the user equipment at least to: deactivate any measurement-ID that fails to meet its condition.

The instructions may cause the user equipment at least to: deactivate any measurement-object that is not linked to any active measurement-ID.

The instructions may cause the user equipment at least to: deactivate any measurement gap or Synchronization Signal Block-based Radio Resource Management Measurement Timing Configuration window which is not related to any active measurement-object.

According to various, but not necessarily all, example embodiments of the invention there is provided a user equipment of a telecommunications network comprising means for receiving a configuration message from a network node, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The user equipment may comprise the optional features set out above.

The user equipment may comprise means for perform measurement activity.

The user equipment may comprise means for activating the second measurement activity when a radio link failure, T310 activation or beam failure associated with the serving PSCell is detected.

The user equipment may comprise means for activating the first measurement activity and for inactivating the second measurement activity when a cell change is executed from the currently serving cell to the target serving cell.

The user equipment may comprise means for activating the second measurement activity when the received signal power is lower by the offset amount than the power measured by the first measurement activity which would lead to conditional handover.

The user equipment may comprise means for activating the second measurement activity when the received signal power is lower by the offset amount than the power measured by the first measurement activity which would lead to conditional handover.

The user equipment may comprise means for deactivating any measurement-ID that fails to meet its condition.

The user equipment may comprise means for deactivating any measurement-object that is not linked to any active measurement-ID.

The user equipment may comprise means for deactivating any measurement gap or Synchronization Signal Block-based Radio Resource Management Measurement Timing Configuration window which is not related to any active measurement-object.

According to various, but not necessarily all, example embodiments of the invention there is provided a method comprising: receiving a configuration message from a network node, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The configuration message may comprise a measurement configuration message and the activity comprises a measurement activity.

The method may comprise performing the measurement activity.

The condition may indicate when the measurement activity is to be in an active state where the measurement activity may be performed by the user equipment or in an inactive state where the measurement activity may not to be performed.

The condition may indicate when the measurement activity is to be in an active state where the measurement activity may be performed by the user equipment connected to the network or in an inactive state where the measurement activity may not to be performed.

The measurement configuration message may indicate whether the measurement activity is by default in the active state or the inactive state.

The condition may indicate when the measurement activity is to switch between the active state and the inactive state.

The measurement configuration message may provide an indication of a plurality of measurement activities to be performed by the user equipment together with a condition related to the measurement activity.

The measurement configuration message may provide an indication of a plurality of measurement activities to be performed by the user equipment connected to the network node together with a condition related to the measurement activity.

The plurality of measurement activities may comprise a first measurement activity having a first condition and a second measurement activity having a second condition, the second condition evaluation being conditional on an outcome of the first condition.

The second measurement activity may have a third condition, the second condition evaluation being conditional on an outcome of the third condition.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when a degradation in the radio conditions measured by the first measurement activity is detected.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when the radio conditions measured by the first measurement activity are detected.

The first measurement activity may comprise radio link monitoring of at least a serving PSCell, the second measurement activity may comprise measuring radio conditions of at least one target PCell and second measurement activity may be switched to the active state when a radio link failure, T310 activation or beam failure associated with the serving PSCell is detected.

The method may comprise activating the second measurement activity when a radio link failure, T310 activation or beam failure associated with the serving PSCell is detected.

The user equipment may be configured for dual connectivity with at least the network node comprising a source master node and with a first secondary node and the configuration message may comprises a handover request acknowledgement received from the master node, the handover request acknowledgement indicating a first activity of applying a configuration for connection with a target master node and the first secondary node when an activated first condition of a radio link failure, T310 activation or beam failure associated with a serving PSCell is not detected and the handover request acknowledgement indicating a second activity of applying a configuration for connection with the target master node and a second secondary node when a deactivated second condition is activated, the deactivated second condition being activated when the first condition is false.

The instructions cause the user equipment at least to: upon detection of the radio link failure, T310 activation or beam failure associated with the serving PSCell, activate the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a conditional cell change from the currently serving cell to the target serving cell commences.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a cell change is executed from the currently serving cell to the target serving cell.

The method may comprise activating the first measurement activity and inactivating the second measurement activity when a cell change is executed from the currently serving cell to the target serving cell.

The user equipment may be configured for dual connectivity with at least the network node comprising a source master node and with a source secondary node and the configuration message may comprise an RRC Reconfiguration message received from the source master node, the RRC Reconfiguration message indicating a first activity of measuring a PSCell of the source secondary node with a first condition of the measuring being deactivated when the user equipment is connected to the source master node, the RRC Reconfiguration message indicating a second activity of measuring a PSCell of the target secondary node with a second condition of the measuring being activated when the user equipment is not connected to the target master node.

The method may comprise, in response to executing conditional primary serving cell change towards the target secondary node, activating the first activity of measuring the PSCell of the source secondary node and deactivating the second activity of measuring the PSCell of the target secondary node.

The method may comprise deactivating by deactivating an associated measurement_ID and activating by activating an associated measurement_ID.

The network node may comprise a source master node.

The configuration message may comprise an RRC Reconfiguration message.

The first measurement activity may comprise measuring radio conditions of a currently serving cell and the second measurement activity may comprise measuring radio conditions of a target serving cell, the first measurement activity may be in the active state by default and the second measurement activity may be in the inactive state by default, the second measurement activity may be switched to the active state when a degradation in the radio conditions measured by the first measurement activity beyond a threshold amount is detected.

The first measurement activity may comprise measuring radio conditions of at least a serving PCell, the second measurement activity may comprise measuring radio conditions of at least a PSCell and the measurement configuration message may provide an indication of a further measurement activity comprising measuring radio conditions of at least a serving PCell and a further condition to be fulfilled prior to switching the second measurement activity to the active state.

The further condition may comprise measuring a received signal power which is lower by an offset amount than the power measured by the first measurement activity which would lead to conditional handover.

The method may comprise activating the second measurement activity when the received signal power is lower by the offset amount than the power measured by the first measurement activity which would lead to conditional handover.

The method may comprise activating the second measurement activity when the received signal power is lower by the offset amount than the power measured by the first measurement activity which would lead to conditional handover.

The user equipment may be configured for dual connectivity with at least the network node comprising a source master node and with a first secondary node and the configuration message may comprise a handover request acknowledgement received from the master node, the handover request acknowledgement indicating a first activity of applying a configuration for connection with a target master node when a first activated condition of measured radio conditions require a conditional handover, a deactivated second condition measuring radio conditions of a PSCell and an activated third condition of determining when measured radio conditions are a predetermined amount lower than those requiring a conditional handover, the second condition being activated when the third condition is true.

The predetermined amount may be for example, 2 dB, but also may be a value in the range of for example 1 to 4 dB.

The method may comprise upon detection the third condition being true, activating the second condition.

The method may comprise upon detection the first condition being true, determining the PSCell addition associated with the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The measurement activity may be associated with a measurement-ID.

The method may comprise deactivating any measurement-ID that fails to meet its condition.

The method may comprise deactivating any measurement-object that is not linked to any active measurement-ID.

The method may comprise deactivating any measurement gap or Synchronization Signal Block-based Radio Resource Management Measurement Timing Configuration window which is not related to any active measurement-object.

According to various, but not necessarily all, example embodiments of the invention there is provided a non-transitory computer readable medium comprising program instructions stored thereon for performing at least the following: receiving a configuration message from a network node, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The instructions may have and perform the optional features of the method set out above.

According to various, but not necessarily all, example embodiments of the invention there is provided a network node of a telecommunications network comprising: at least one processor; and at least one memory storing instructions that, when executed by the at least one processor, cause the network node at least to: transmit a configuration message to a user equipment, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The configuration message may comprise a measurement configuration message and the activity may comprise a measurement activity.

The condition may indicate when the measurement activity is to be in an active state where the measurement activity is to be performed by the user equipment or in an inactive state where the measurement activity is not to be performed.

The condition may indicate when the measurement activity is to be in an active state where the measurement activity is to be performed by the user equipment connected to the network or in an inactive state where the measurement activity is not to be performed.

The measurement configuration message may indicate whether the measurement activity is by default in the active state or the inactive state.

The condition may indicate when the measurement activity is to switch between the active state and the inactive state.

The measurement configuration message may provide an indication of a plurality of measurement activities to be performed by the user equipment together with a condition related to the measurement activity.

The measurement configuration message may provide an indication of a plurality of measurement activities to be performed by the user equipment connected to the network node together with a condition related to the measurement activity.

The plurality of measurement activities may comprise a first measurement activity having a first condition and a second measurement activity having a second condition, the second condition evaluation being conditional on an outcome of the first condition.

The second measurement activity may have a third condition, the second condition evaluation being conditional on an outcome of the third condition.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when a degradation in the radio conditions measured by the first measurement activity is detected.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when the radio conditions measured by the first measurement activity are detected.

The first measurement activity may comprise radio link monitoring of at least a serving PSCell, the second measurement activity may comprise measuring radio conditions of at least one target PCell and second measurement activity may be switched to the active state when a radio link failure, T310 activation or beam failure associated with the serving PSCell is detected.

The user equipment is may be configured for dual connectivity with at least the network node comprising a source master node and with a first secondary node and the configuration message comprises a handover request acknowledgement transmitted from the master node, the handover request acknowledgement indicating a first activity of applying a configuration for connection with a target master node and the first secondary node when an activated first condition of a radio link failure, T310 activation or beam failure associated with a serving PSCell is not detected and the handover request acknowledgement indicating a second activity of applying a configuration for connection with the target master node and a second secondary node when a deactivated second condition is activated, the deactivated second condition being activated when the first condition is false.

The instructions may cause the user equipment at least to: upon detection of the radio link failure, T310 activation or beam failure associated with the serving PSCell, activate the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a conditional cell change from the currently serving cell to the target serving cell commences.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a cell change is executed from the currently serving cell to the target serving cell.

The user equipment may be configured for dual connectivity with at least the network node comprising a source master node and with a source secondary node and the configuration message may comprise an RRC Reconfiguration message transmitted from the source master node, the RRC Reconfiguration message indicating a first activity of measuring a PSCell of the source secondary node with a first condition of the measuring being deactivated when the user equipment is connected to the source master node, the RRC Reconfiguration message indicating a second activity of measuring a PSCell of the target secondary node with a second condition of the measuring being activated when the user equipment is not connected to the target master node.

The network node may comprise a source master node.

The configuration message may comprise an RRC Reconfiguration message.

The first measurement activity may comprise measuring radio conditions of a currently serving cell and the second measurement activity may comprise measuring radio conditions of a target serving cell, the first measurement activity may be in the active state by default and the second measurement activity may be in the inactive state by default, the second measurement activity may be switched to the active state when a degradation in the radio conditions measured by the first measurement activity beyond a threshold amount is detected.

The first measurement activity may comprise measuring radio conditions of at least a serving PCell, the second measurement activity may comprise measuring radio conditions of at least a PSCell and the measurement configuration message may provide an indication of a further measurement activity comprising measuring radio conditions of at least a serving PCell and a further condition to be fulfilled prior to switching the second measurement activity to the active state.

The further condition may comprise measuring a received signal power which is lower by an offset amount than the power measured by the first measurement activity which would lead to conditional handover.

The user equipment may be configured for dual connectivity with at least the network node comprising a source master node and with a first secondary node and the configuration message may comprise a handover request acknowledgement transmitted from the master node, the handover request acknowledgement indicating a first activity of applying a configuration for connection with a target master node when a first activated condition of measured radio conditions require a conditional handover, a deactivated second condition measuring radio conditions of a PSCell and an activated third condition of determining when measured radio conditions are a predetermined amount lower than those requiring a conditional handover, the second condition being activated when the third condition is true.

The predetermined amount may be for example, 2 dB, but also may be a value in the range of for example 1 to 4 dB.

The instructions may cause the user equipment at least to: upon detection the third condition being true, activate the second condition.

The instructions may cause the user equipment at least to: upon detection the first condition being true, determine the PSCell addition associated with the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The measurement activity may be associated with a measurement-ID.

According to various, but not necessarily all, example embodiments of the invention there is provided a network node of a telecommunications network comprising: means for transmitting a configuration message to a user equipment, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The user equipment may comprise the optional features set out above.

According to various, but not necessarily all, example embodiments of the invention there is provided a method, comprising: transmitting a configuration message to a user equipment, the configuration message providing an indication of an activity to be performed by the user equipment together with a condition related to the activity.

The configuration message may comprise a measurement configuration message and the activity may comprise a measurement activity.

The condition may indicate when the measurement activity is to be in an active state where the measurement activity is to be performed by the user equipment or in an inactive state where the measurement activity is not to be performed.

The condition may indicate when the measurement activity is to be in an active state where the measurement activity is to be performed by the user equipment connected to the network or in an inactive state where the measurement activity is not to be performed.

The measurement configuration message may indicate whether the measurement activity is by default in the active state or the inactive state.

The condition may indicate when the measurement activity is to switch between the active state and the inactive state.

The measurement configuration message may provide an indication of a plurality of measurement activities to be performed by the user equipment together with a condition related to the measurement activity.

The measurement configuration message may provide an indication of a plurality of measurement activities to be performed by the user equipment connected to the network node together with a condition related to the measurement activity.

The plurality of measurement activities may comprise a first measurement activity having a first condition and a second measurement activity having a second condition, the second condition evaluation being conditional on an outcome of the first condition.

The second measurement activity may have a third condition, the second condition evaluation being conditional on an outcome of the third condition.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when a degradation in the radio conditions measured by the first measurement activity is detected.

The first measurement activity may comprise measuring radio conditions of at least one serving cell and the second measurement activity may comprise measuring radio conditions of at least one target cell, the first measurement activity may be in the active state by default and the second measurement activity may be in the inactive state by default and the second measurement activity may be switched to the active state when the radio conditions measured by the first measurement activity are detected.

The first measurement activity may comprise radio link monitoring of at least a serving PSCell, the second measurement activity may comprise measuring radio conditions of at least one target PCell and second measurement activity may be switched to the active state when a radio link failure, T310 activation or beam failure associated with the serving PSCell is detected.

The user equipment may be configured for dual connectivity with at least the network node comprising a source master node and with a first secondary node and the configuration message may comprises a handover request acknowledgement transmitted from the master node, the handover request acknowledgement indicating a first activity of applying a configuration for connection with a target master node and the first secondary node when an activated first condition of a radio link failure, T310 activation or beam failure associated with a serving PSCell is not detected and the handover request acknowledgement indicating a second activity of applying a configuration for connection with the target master node and a second secondary node when a deactivated second condition is activated, the deactivated second condition being activated when the first condition is false.

The instructions may cause the user equipment at least to: upon detection of the radio link failure, T310 activation or beam failure associated with the serving PSCell, activate the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The first measurement activity may comprise measuring radio conditions of a currently serving cell and the second measurement activity may comprise measuring radio conditions of a target serving cell, the first measurement activity may be in the inactive state by default and the second measurement activity may be in the active state by default, the second measurement activity may be switched to the inactive state and the first measurement activity may be switched to the active state when a conditional cell change from the currently serving cell to the target serving cell commences.

The first measurement activity may comprise measuring radio conditions of a currently serving cell and the second measurement activity may comprise measuring radio conditions of a target serving cell, the first measurement activity may be in the inactive state by default and the second measurement activity may be the active state by default, the second measurement activity may be switched to the inactive state and the first measurement activity may be switched to the active state when a cell change is executed from the currently serving cell to the target serving cell.

The user equipment may be configured for dual connectivity with at least the network node comprising a source master node and with a source secondary node and the configuration message comprises an RRC Reconfiguration message transmitted from the source master node, the RRC Reconfiguration message indicating a first activity of measuring a PSCell of the source secondary node with a first condition of the measuring being deactivated when the user equipment is connected to the source master node, the RRC Reconfiguration message indicating a second activity of measuring a PSCell of the target secondary node with a second condition of the measuring being activated when the user equipment is not connected to the target master node.

The network node may comprise a source master node.

The configuration message may comprise an RRC Reconfiguration message.

The first measurement activity may comprise measuring radio conditions of a currently serving cell and the second measurement activity may comprise measuring radio conditions of a target serving cell, the first measurement activity may be in the active state by default and the second measurement activity may be in the inactive state by default, the second measurement activity may be switched to the active state when a degradation in the radio conditions measured by the first measurement activity beyond a threshold amount is detected.

The first measurement activity may comprise measuring radio conditions of at least a serving PCell, the second measurement activity may comprise measuring radio conditions of at least a PSCell and the measurement configuration message may provide an indication of a further measurement activity comprising measuring radio conditions of at least a serving PCell and a further condition to be fulfilled prior to switching the second measurement activity to the active state.

The further condition may comprise measuring a received signal power which is lower by an offset amount than the power measured by the first measurement activity which would lead to conditional handover.

The user equipment may be configured for dual connectivity with at least the network node comprising a source master node and with a first secondary node and the configuration message comprises a handover request acknowledgement transmitted from the master node, the handover request acknowledgement indicating a first activity of applying a configuration for connection with a target master node when a first activated condition of measured radio conditions require a conditional handover, a deactivated second condition measuring radio conditions of a PSCell and an activated third condition of determining when measured radio conditions are a predetermined amount lower than those requiring a conditional handover, the second condition being activated when the third condition is true.

The predetermined amount may be for example, 2 dB, but also may be a value in the range of for example 1 to 4 dB.

The instructions may cause the user equipment at least to: upon detection the third condition being true, activate the second condition.

The instructions may cause the user equipment at least to: upon detection the first condition being true, determine the PSCell addition associated with the second condition.

The network node may comprise a target master node or a source master node.

When the network node comprises the source master node, the configuration message may comprise an RRC Reconfiguration message.

When the network node comprises the target master node, the configuration message may comprise an HO Request Ack message.

The measurement activity may be associated with a measurement-ID.

According to various, but not necessarily all, example embodiments of the invention there is provided a non-transitory computer readable medium comprising program instructions stored thereon for performing at least the following: transmitting a configuration message to a user equipment, the configuration message providing an indication of an activity to be performed by the user equipment together with a condition related to the activity, wherein the condition indicates when the activity is to be in an active state where the activity is to be performed by the user equipment connected to the network or in an inactive state where the measurement activity is not to be performed.

The instructions may have and perform the optional features of the method set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

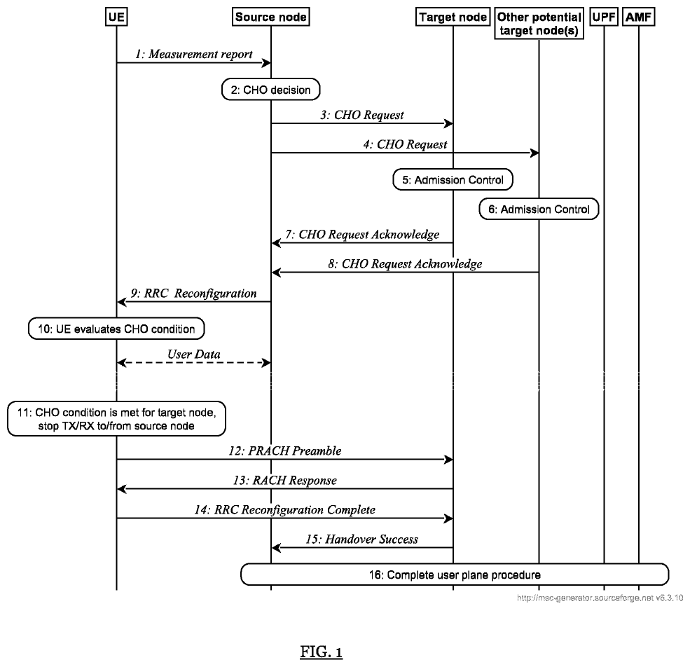

FIG. 1 illustrates messaging during Conditional Handover (CHO) for intra-New Radio (NR);

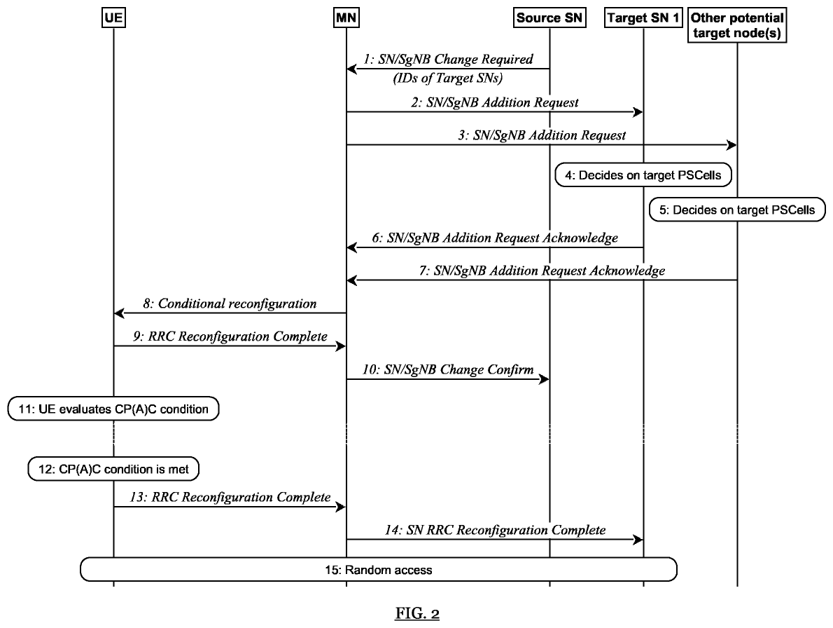

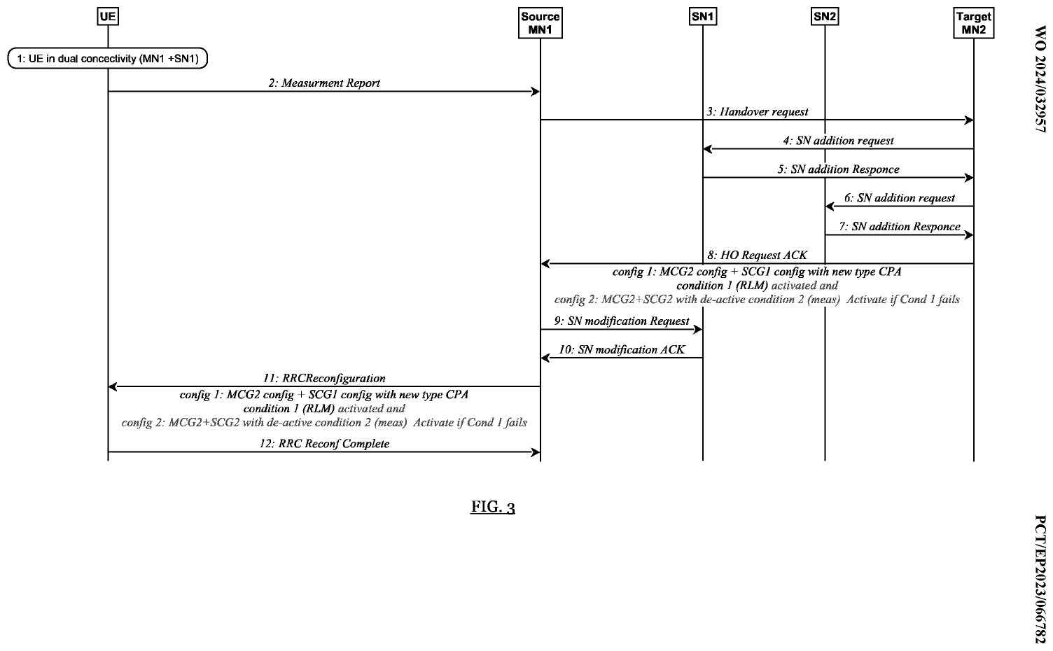

FIG. 2 illustrates messaging during Secondary Node (SN) initiated Inter-SN Conditional Primary Secondary Cell Change;

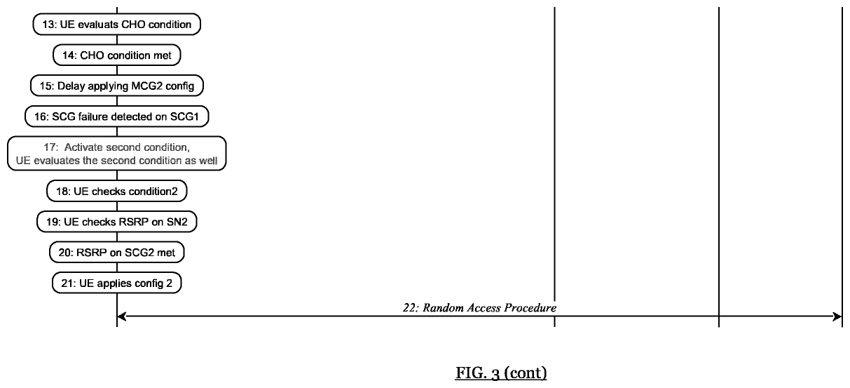

FIG. 3 illustrates messaging for conditional activation in the case of a CHO+PSCell change RLM based scenario according to an example embodiment;

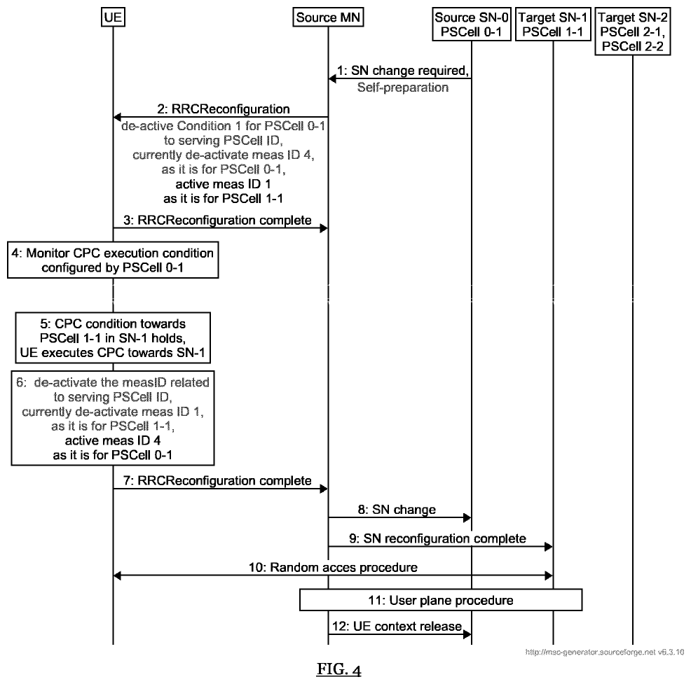

FIG. 4 illustrates messaging for conditional activation in the case of a selective activation according to an example embodiment;

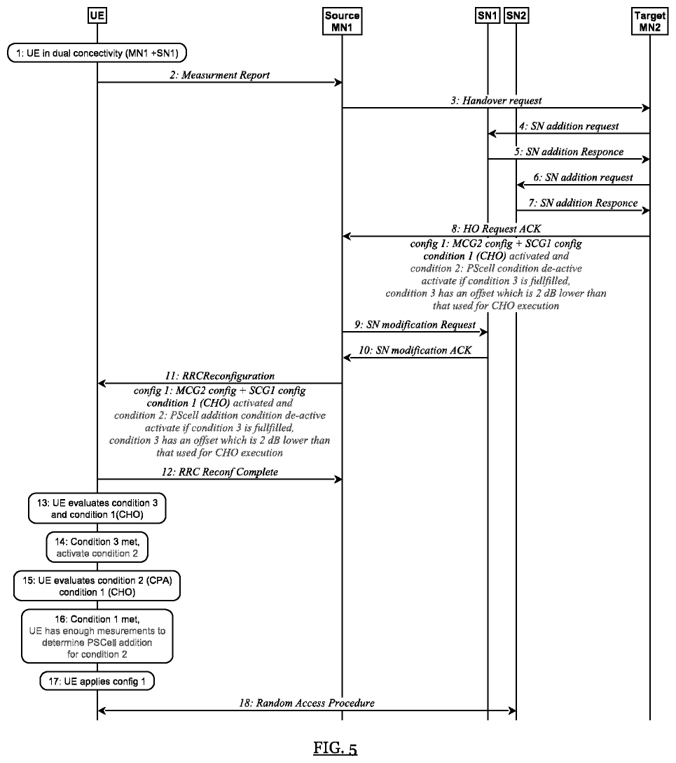

FIG. 5 illustrates messaging for conditional activation in the case of CHO+MR-DC according to an example embodiment;

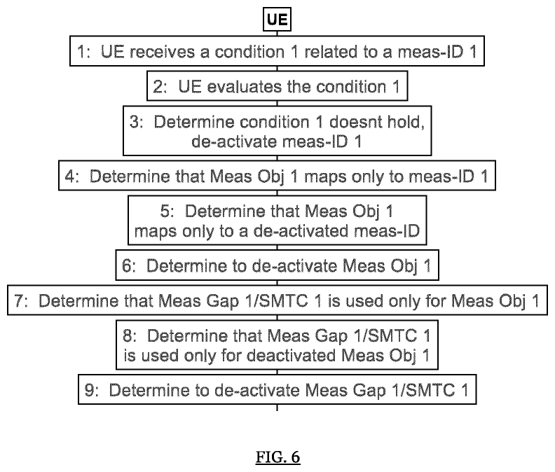

FIG. 6 illustrates steps performed by a user equipment for measurement activation/de-activation according to an example embodiment; and

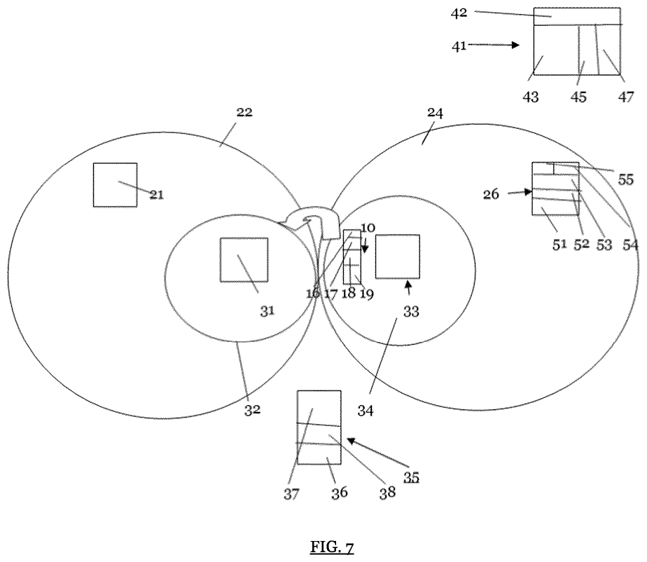

FIG. 7 illustrates a 5G new radio network according to an example embodiment.

### DETAILED DESCRIPTION

Before discussing the example embodiments in any more detail, first an overview will be provided. Some example embodiments recognise that some events where a user equipment (UE) is expected to perform activities for all execution conditions it has been configured with as soon as a new configuration is received can be wasteful of resources. Accordingly, some example embodiments provide a technique whereby the configuration message(s) which provide or encodes an indication of the activity to be performed by the user equipment also provides or is encoded with an indication of one or more conditions relating to performance of that activity. The configuration message is typically transmitted from a network node (sometimes via another network node) of the wireless telecommunications network to the user equipment. The indications are typically encoded in existing configuration messages passing between the network node and the user equipment. The user equipment will typically then perform or activate that activity when the condition is met and avoid performing or deactivate that activity when the condition is not met or vice-versa. The configuration message(s) may also provide or encode an indication of whether the activity to be performed is to be activated or deactivated by default. Multiple conditions may be configured and may be processed in a hierarchical order, cascaded or dependent on each other. The conditions are typically configured to prevent the user equipment from performing an activity when it has been determined by the network that performing the activity under those conditions would be a waste of resources.

Before discussing example embodiments in detail, the following provides some background information. As shown in FIG. 1, in Conditional Handover (CHO) Rel. 16, user equipment (UE) is configured with CHO target cell configurations and at least one CHO execution condition to decide on when to execute the handover to one or multiple prepared target cells. The condition is based on radio measurements of the serving cell and target cells. In the CHO configuration, the target cell may have a reserved Cell Radio Network Temporary Identifier (C-RNTI) and contention-free random access (CFRA) resources for the UE. When the UE evaluates the CHO condition and the condition holds for a specific target cell, the UE applies the CHO configuration of the target cell and may use the reserved CFRA resources to initiate the random access to the target cell. The UE can be configured with multiple conditions for multiple target cells. CHO is designed so that the UE can trigger the handover execution (once the CHO execution condition is met) without the need of the serving cell to send additional handover command to trigger the HO execution after receiving a measurement report from the UE (as shown in Step 1 of FIG. 1). At Step 1: the UE sends the measurement report identifying potential neighbour cells for handover. At Steps 2-8: In response to the measurements received in Step 1, the source node determines that the CHO should be prepared for the UE—the source Radio Access Network (RAN) node sends a CHO Request to multiple target RAN nodes—in each CHO request message, the source node indicates the target Primary Cell (PCell) that shall be prepared by target node—the target RAN nodes does admission control and sends a Handover request Acknowledgement (ACK) for the requested PCell and the related Conditional Configuration as a response to the HO request. At Step 9: the source RAN node sends the Radio Resource Control (RRC)Reconfiguration message with the Conditional Configurations related to CHO to the UE. At Steps 10-11: the UE evaluates the CHO execution conditions, and executes the conditional configuration towards a prepared target cell for the CHO for which the condition held. At Steps 11-14: the UE executes CHO towards the target cell controlled by the target RAN node. At Step 15: the target RAN node indicates the handover success to the source RAN Node. At Step 16: the user plane procedures such as data forwarding and path switch are completed afterwards.

In Rel. 16, Conditional Primary Serving Cell (PSCell) Change (CPC) has been specified for an intra-Secondary Node (SN) scenario [TS 37.340]. CPC has been extended in Rel. 17 for inter-SN scenarios where it has two flavours: Master Node (MN)-initiated CPC and SN-initiated CPC [R2-2111640]. This is illustrated in FIG. 2 which shows on high-level an exemplary signalling diagram for SN-initiated Conditional Primary Serving Cell (PSCell) Addition and Change (CPAC): At Step 1, the source SN indicates to MN the Identifiers (IDs) of the target SNs that shall be contacted for preparing target PSCell(s). The source SN suggests a list of PSCell(s) to be prepared by each target SN and provides a CPC execution condition for each suggested target PSCell. At Steps 2-3, the MN sends an addition request to each target SN indicated by the source SN. At Steps 4-5, the target SN decides on the candidate target PSCell(s) to prepare among the list of PSCells that are suggested by source SN to be prepared. At Steps 6-7, the target SN sends to MN the CPC configuration for each prepared target PSCell and the ID of the prepared target PSCell(s). At step 8, the MN sends to the UE a conditional (re-)configuration containing the CPC configurations of the candidate target PSCell(s) along with the CPC execution conditions. At step 9, the UE sends a message to MN confirming the reception of the conditional configuration and MN confirms in turn to source SN the SN change preparation in Step 10. At Step 11, the UE evaluates the CPC execution conditions of the prepared target PSCell(s). At step 12, the CPC execution condition is met for e.g. a PSCell candidate in target SN 1. The UE sends a message to MN at Step 13 indicating the execution of the CPC configuration. The message includes an embedded SN RRC Reconfiguration Complete to the target SN 1 which is sent at Step 14. The UE completes the random access at Step 15.

As described above, several mobility mechanisms rely on dual execution events (CHO for single or dual connectivity) or two sperate execution conditions (CHO+CPAC). Based on the current specifications, the UE is expected to start measuring for all execution conditions it has been configured with as soon as a new configuration is received, i.e., a target cell is prepared. However, this suboptimal in certain cases, as will be described in more detail below. More specifically, the UE may be performing unnecessary measurements resulting in energy waste and/or needless allocation of measurement gaps. These can be timing-based cases: CHO+CPAC: the UE is configured with two measurement-IDs, one for PCell and another for the PSCell. Measurement-ID 1 may be an A3 event for PCell change, with Time To Trigger (TTT) of 150 ms. Measurement-ID 2 may be another A3 event for PSCell change, with TTT of 0 ms, and the PSCell change is to be triggered immediately after PCell change. Also in this case, measurement-ID 2 shouldn't be started before measurement-ID 1 as the UE cannot execute PSCell change before PCell change. In Rel 18 selective activation feature of cell group, the serving cell may provide the user with its own conditional reconfiguration to be applied by the UE in case it needs to switch back to the serving cell group. The condition which is associated with own condition reconfiguration should be evaluated only if the UE is no longer served by this cell. Otherwise, the UE would be unnecessary evaluating a condition that will never met, i.e. the UE would be comparing its own serving cell power against the same cell power and not against a neighbour cell. These can also be measurement-based cases: Dual event execution for CHO/PCell change: the UE may be configured with two execution conditions, one based on Reference Signal Received Power (RSRP) and one based on Reference Signal Received Quality (RSRQ). As the common denominator of the two quantities is RSRP, if RSRP is below a given certain threshold then RSRQ may not be higher than another certain threshold. So as long as the first condition does not hold, it may be energy waste for the UE to start measuring the other condition. Hence, the UE wastes energy by measuring RSRQ while RSRP is bad. CHO+PSCell change RLM based scenario: the target MN may prepare several PSCells for the UE including the currently serving one and the condition for PSCell change may be RSRP related. As long as the Radio Link Monitoring (RLM) for the currently serving PSCell is good, it may be unnecessary to measure the other prepared PSCells. One way to stop the UE from conducting measurements would be explicit RRC Reconfiguration with new measurement configurations sent to UE each time a measurement is to be initiated and to be stopped. The current objective 2 in the mobility enhancement work item tries to avoid the case where the UE is frequently re-configured to minimize signalling overhead.

Some example embodiments propose including additional criteria or conditions to measurement-ID or other activity identifiers within the measurement or other activity configuration messages to start and stop the UE measurements or other activities associated with the measurement-ID or other activity identifier. The additional criteria can be e.g. another measurement-ID, trigger points, etc. In other words: a condition is introduced to activate and/or deactivate a measurement or other activity. The UE is enabled to autonomously monitor the fulfilment of the condition and thus can activate/deactivate relevant measurements or other activity on its own providing an efficient use of resources and concentrate on the most valuable/relevant measurements or activities. Multiple conditions can be configured, e.g. to be processed in a hierarchical order, cascaded or dependent on each other. These additional criteria will now be described in more detail.

### Another Measurement-ID

In this case, the UE will start or activate a measurement-ID only if an event or condition associated with another measurement-ID is met. This can be employed in, for example, the following scenario: dual conditions for DC-CHO execution.

In one example embodiment, the UE starts the measurement of a target PSCell only if another measurement-ID of the target PCell is met where the parameters for this measurement-ID are configured by the network in a way which is met way before the CHO condition is met. For instance, assume that the network provides a CHO condition with an execution offset of 3 dB for the target PCell, i.e., handover is executed if the target PCell is 3 dB stronger than the source cell. The network may provide another condition with an offset of 1 dB which once met, would trigger the UE to start the evaluation of the target PSCell. In this way, the UE only starts to evaluate the measurement of target PSCells when the CHO condition is about to be met for the corresponding target PCell.

It will be appreciated that the use of particular 1 dB and 3 dB offsets mentioned above are only examples and could be configured by the network to be other values such as those within a range of around 0.5 dB to 5 dB. These may be dependent on network conditions, or set for each user equipment individually, or preconfigured, or the like. Typically, the offset has a smaller amount than the execution offset.

### Interim Trigger Points of Other Measurement-ID

In this case, the measurements are linked to interim stages of other measurement-IDs such as start of time-to-trigger or offset from the actual event threshold. This approach avoids delay in starting the depended measurements.

In one example embodiment, the UE might be provided in CHO with a condition for target PSCells which are associated with a prepared target PCell. As long as the entering condition of the target PCell is not fulfilled, the UE may not have to evaluate the condition of the PSCell. That is the UE evaluates the measurement-ID of a target PScell only if the entering condition of the corresponding target PCell is met.

In one example embodiment, the UE evaluates the measurement-ID of a target PSCell only if the TTT of a target PCell exceeds certain value.

### Serving Cell

In this case, the UE de-activates the evaluation of the measurement ID (triggering conditional reconfiguration) that is associated with the serving cell ‘X’ as long as the UE is served by that serving cell ‘X’.

In one example embodiment, the UE does not evaluate the condition associated with the conditional reconfiguration of the cell the UE is connected to. As long as the UE is served by the cell for which it has a conditional reconfiguration it does not evaluate the condition related to that conditional reconfiguration. For instance, this approach can be used where there can be a common measurement-config to cover all the measurement-ID(s) of all participating cell(s).

### Specific Trigger Points

In this case, the UE activates and performs the evaluation of a measurement ID if the UE detects either a: Radio Link Failure (RLF) or start of T310 (or radio link degradation) in any of the serving cell-group, or a Beam Failure event. This is also applicable to the CHO+PSCell change RLM based scenario that is described above.

In case a measurement object maps to only de-activated measurement-IDs, the UE can de-activate that measurement. In the case that a Synchronization Signal Block (SSB)-based Radio Resource Management (RRM) Measurement Timing Configuration (SMTC) window and a measurement gap are only configured for de-activated measurement objects, the scheduling restrictions related to that SMTC or measurement gap are not applied by the UE anymore. The UE may indicate the status of the scheduling restriction, the SMTC window, the measurement gap or the measurement object to the network. The network may make use of this information to schedule or re-configure the UE. This approach will save energy and/or save the configuration of a measurement gap for the UE and will reduce also the number or reconfigurations the network has to do.

### CHO+PSCell Change RLM Example

FIG. 3 shows the main steps for conditional activation in case of a CHO+PSCell change RLM based scenario.

At Step 1, the UE is configured with dual connectivity provided by MN1 and SN1.

At Steps 2-7, based on measurement reports received from the UE, the Source MN1 is preparing CHO to the Target MN2 and the Target MN2 is preparing CPAC for SN1 and SN2.

At Step 8, the target MN2 sends to the source MN1 the HO Request ACK including 2 configurations:

Configuration 1 containing MCG2 configuration+SCG1 configuration with activated CPA condition 1. Condition 1 is RLM based where the UE would apply the SCG1 configuration if the UE does not detect a degradation in the radio condition of the serving PSCell in SN 1, i.e., RLF is not detected for the serving PSCell, or T310 did not start for the serving PSCell, or beam failure is not detected for the serving PSCell, etc.

Configuration 2 containing MCG2 configuration+SCG2 configuration with de-activated condition 2. Condition 2 is the measurement ID that is associated with SCG2 and will be only activated if condition 1 is not fulfilled.

At Steps 9 to 11, the Source MN1 signals the SN modification to SN1 and MN1 sends the RRC Reconfiguration message to the UE including the two configurations received from target MN2. The measurement object is linked only to the measurement-ID of condition 2. As condition 2 is disabled the measurement object can be disabled as well. The UE de-activates the measurement gap or SMTC related to the measurement ID of condition 2.

At Steps 13 to 14 the UE evaluates first the CHO condition which is later on met. The UE delays applying the MCG2 configuration and checks the activated condition in configuration 1. The delay of MCG2 configuration application should be over bounded to not risk RLF.

At Step 16, if SCG failure is detected on SCG1, the second condition, belonging to configuration 2, is activated and evaluated by the UE at Steps 17 to 20. As condition 2 is activated, the measurement object is activated as well and UE starts doing measurements. As the measurement object is activated, UE activates the SMTC and measurement gap.

If the second condition is met, the UE applies configuration 2 and accesses SN2.

### Conditional Activation in Case of Selective Activation Example

FIG. 4 shows the main steps for conditional activation in case of selective activation. For the case of self-preparation during inter-SN CPC, the UE starts in dual connectivity with MN and SN0-PSCell 0-1. The Source SN-0 sends the conditional configuration related to PSCell 0-1—this is called self-preparation. This is a conditional configuration for the serving PSCell. The trigger for such a self-preparation can be: preparation of other CPC and CPA; triggering of a PSCell change.

At Step 1, the Source SN 0 indicates to the MN the need for SN change which includes the self-preparation configuration.

At Steps 2-3, the Source MN sends an RRC Reconfiguration to the UE including: the de-activated condition 1 for self-preparation of PSCell 0-1 which also deactivates the corresponding measurement-ID which is acknowledged by the UE.

At Step 4, the UE monitors the CPC execution condition configured by PScell 0-1.

At Step 5, the CPC condition towards PScell 1-1 in Target SN 1 holds and the UE accesses it.

At Step 6, the UE activates the measurement-ID 4 as it is for PSCell 0-1 and it de-activates the measurement-ID 1 for PSCell 1-1 as the PSCell 1-1 is now the serving PSCell.

### Conditional Activation in Case of CHO+MR-DC Example

FIG. 5 shows the main steps for conditional activation in case of CHO+MR-DC.

At Step 1, for of CHO+MR-DC (CPAC), the UE starts in dual connectivity with MN1 and SN1.

At Steps 2 to 7, source MN1 prepares CHO to Target MN2 which in turn prepares SN1 and SN2.

At Steps 8 to 11, MN2 sends MN1 the HO Request acknowledge including configuration 1 for MCG2+SCG1 comprising two conditions: CHO condition 1 (Activated) and de-activated condition 2 corresponding to PScell change. Condition 2 is to be activated if another condition, condition 3 is valid. In this example condition 3 has an offset which is 2 dB lower than the offset of CHO execution condition. The HO command is sent to the UE.

At Step 13, the UE evaluates conditions 1 and 3.

At Step 14, when condition 3 is met, condition 2 is activated.

At Step 15, the UE evaluates condition 2 (for CPA) and condition 1 (for CHO).

At Step 16, when condition 1 is met, the UE has enough measurements to determine PSCell addition for condition 2.

At Steps 17 to 18, the UE applies configuration 1 and accesses SN2.

### UE Operation Example

FIG. 6 shows the main steps performed by a UE for measurement activation/de-activation.

At Step 1, the UE receives a condition 1 related to measurement-ID1.

At Steps 2-3, after the UE evaluates condition 1 and determines that it does not hold, it deactivates measurement-ID1.

At Steps 4-6, upon determining that measurement-Object1 only maps to the measurement-ID1 and that this is deactivated, the UE deactivates measurement-Object1.

At Steps 7-9, since measurement-gap 1 config/SMTC1 is only used for measurement-Object1 which is deactivated, this too shall be deactivated.

It will be appreciated that this approach can be utilised for multiple measurement-IDs relating to the same measurement-object, with the measurement-object only being deactivated when all the measurement-IDs relating to that measurement-object are deactivated. Likewise, this approach can be utilised for multiple measurement-objects relating to the same measurement-gap/SMTC, with the measurement-gap/SMTC only being deactivated when all the measurement-objects relating to that measurement-gap/SMTC are deactivated.

Using this approach, the UE can perform the measurements optimally and on time, minimizing energy waste and/or the allocation of measurement gaps.

FIG. 7 schematically shows a 5G new radio network according to an embodiment. This network comprises a plurality of primary cells 22, 24 and a plurality of secondary cells 32, 34. Radio coverage within primary cell 22 is supported by master distributed node 21 while master distributed node 26 supports providing radio coverage within primary cell 24. Master distributed node 21 and master distributed node 26 are both controlled by master central node 41.

There are secondary cells 32 and 34 and radio coverage in these cells is supported by secondary distributed nodes 31 and 33 respectively. Secondary distributed node 31 and secondary distributed node 33 are controlled by secondary central node 35. User equipment 10 is in this example currently connected to secondary cell 34 supported by secondary distribution node 33 and primary cell 24 supported by distributed node 26. Thus, user equipment 10 is operating in a dual connectivity mode. In this example, user equipment 10 is moving from secondary cell 34 to secondary cell 32 and at the same time it is moving from master cell 24 to master cell 22.

User equipment 10 comprises a receiver 16 for receiving signals and this may be a means for receiving or circuitry configured to receive. User equipment 10 further comprises a means for establishing dual connectivity 17 which may be circuitry configured to established dual connectivity and a means for performing measurements 18 which again may be circuitry configured to perform measurements, which measurements may be L1 signal strength and/or quality measurements. User equipment 10 also comprises a transmitter 19 or means for transmitting. The receiver 16 may receive from distributed node 26 measurement configuration information for performing measurements related to a non-serving mater cell in this case cell 22 and a secondary cell in this case cell 32 these being the two cells for the target handover. The user equipment may respond to receipt of this by performing the measurements for these cells and transmitting the measurement report to the distributed node 26.

This is only an example and in other embodiments, there may be more cells for which measurement configuration information is received and measurements performed and in other embodiments, the serving secondary cell may straddle two master cells, in which case the measurements performed for the secondary cell may relate to the current serving secondary cell but the measurements may be for reconfigured frequency bands for example, for this cell.

The serving master distributed node 26 comprises a receiver 51 which may be receiving means or circuitry configured to receive that receives the measurement report and in response to this using decision making means 52 or circuitry configured to perform handover decisions makes a handover decision relating to the cells to handover to. The serving master distributed node 26 following making the handover decision uses means for generating or circuitry configured to generate a cell change indication 53 to generate a cell change indication that indicates any change in the primary serving cell and in the secondary cell determined in the handover decision. It then transmits this information towards the user equipment as part of a layer two message using means for transmitting 54.

Prior to the user equipment receiving the measurement configuration information and the steps above being performed there will have been some coordination between the secondary and master central nodes.

The serving master central node 41 will coordinate with the serving secondary central node 35 to determine the configuration of primary cells prepared for lower layer mobility and the corresponding changes that may be required in secondary cell configuration and/or the configuration of secondary cells prepared for lower layer mobility.

The master central node 41 use means for determining or circuitry configured to determine 43 to determine the primary cells prepared for lower layer mobility and will transmit this information towards the secondary central node 35 using transmitting means 45 or circuitry configured to transmit either as a secondary node addition request or a secondary node modification request.

The secondary central node 35 receives this information at receiver 37 and in response using means for generating configuration information 36 or circuitry configured to generate configuration information generates configuration for at least one secondary cell that is compatible with the master cells prepared for lower layer mobility and may transit this configuration information using transmitter 38 in a secondary node addition or a secondary node modification response.

The master central node 41 comprises means for receiving 47 or circuitry configured to receive and receives this secondary cell configuration information. The master central node 41 then liaises with the serving master distributed node to generate reconfiguration information for the primary cells and the at least one reconfigured secondary cell using means for generating or circuitry configured to generate a measurement configuration request 42, the configuration request indicating a plurality of primary cells and at least one secondary cell for which measurement information is required. This is transmitted to the serving master distributed node using the transmitting means 45.

The serving master distributed node 26 receives this at receiver 51 and forwards the measurement configuration information using means for forwarding 55 to the user equipment 10 so that the user equipment can perform the measurements described above.

The following description may provide further details of alternatives, modifications and variances: a gNB comprises e.g. a node providing NR user plane and control plane protocol terminations towards the UE, and connected via the NG interface to the 5GC, e.g. according to 3GPP TS 38.300 V16.6.0 (2021-06) section 3.2 incorporated by reference.

A gNB Central Unit (gNB-CU) comprises e.g. a logical node hosting e.g. RRC (radio resource control), SDAP (service data adaptation protocol) and PDCP (packet data convergence protocol) protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC (radio link control), MAC (medium access control) and PHY (physical) layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021-07) section 3.1 incorporated by reference.

Different functional splits between the central and distributed unit are possible, e.g. called options:

### Option 1 (1A-Like Split)

The function split in this option is similar to the 1A architecture in DC. RRC is in the central unit. PDCP, RLC, MAC, physical layer and RF are in the distributed unit.

### Option 2 (3C-Like Split)

The function split in this option is similar to the 3C architecture in DC. RRC and PDCP are in the central unit. RLC, MAC, physical layer and RF are in the distributed unit.

### Option 3 (Intra RLC Split)

Low RLC (partial function of RLC), MAC, physical layer and RF are in the distributed unit. PDCP and high RLC (the other partial function of RLC) are in the central unit.

### Option 4 (RLC-MAC Split)

MAC, physical layer and RF are in the distributed unit. PDCP and RLC are in the central unit.

Or else, e.g. according to 3GPP TR 38.801 V14.0.0 (2017-03) section 11 incorporated by reference.

A gNB supports different protocol layers, e.g. Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. to segmentation;
Control channels include (BCCH, PCCH).

Layer 3 (L3) includes e.g. Radio Resource Control (RRC), e.g. according to 3GPP TS 38.300 V16.6.0 (2021-06) section 6 incorporated by reference.

A RAN (Radio Access Network) node or network node or central node or distributed node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc. A central node may e.g. implement CU-CP and/or CP-UP functionality.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021-06) sections 42.1 and 4.4, incorporated by reference).

A UE is e.g. either in RRC_CONNECTED state or in RRC_INACTIVE state when an RRC connection has been established.

In RRC_CONNECTED state a UE may:
store the AS context;
   transfer unicast data to/from the UE;
   monitor control channels associated with the shared data channel to determine if data is scheduled for the data channel;
   provide channel quality and feedback information;
   perform neighboring cell measurements and measurement reporting;

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-32. (canceled)

33. A user equipment for connecting to a telecommunications network comprising:
at least one processor; and
at least one memory storing instructions that, when executed by the at least one processor, cause the user equipment at least to:
receive a configuration message from a network node, said configuration message providing an indication of an activity to be performed by said user equipment together with a condition related to said activity, wherein said condition indicates when said activity is to be in an active state where said activity is to be performed by said user equipment connected to said network or in an inactive state where said measurement activity is not to be performed.

34. The user equipment of claim 33, wherein said configuration message comprises a measurement configuration message and said activity comprises a measurement activity.

35. The user equipment of claim 34, wherein said measurement configuration message indicates whether said measurement activity is by default in said active state or said inactive state.

36. The user equipment of claim 34, wherein said condition indicates when said measurement activity is to switch between said active state and said inactive state.

37. The user equipment of claim 34, wherein said measurement configuration message provides an indication of a plurality of measurement activities to be performed by said user equipment connected to said network node together with a condition related to said measurement activity.

38. The user equipment of claim 37, wherein said plurality of measurement activities comprise a first measurement activity having a first condition and a second measurement activity having a second condition, said second condition evaluation being conditional on an outcome of said first condition.

39. The user equipment of claim 38, wherein said second measurement activity has a third condition, said second condition evaluation being conditional on an outcome of said third condition.

40. The user equipment of claim 38, wherein said first measurement activity comprises measuring radio conditions of at least one serving cell and said second measurement activity comprises measuring radio conditions of at least one target cell, said first measurement activity is in said active state by default and said second measurement activity is in said inactive state by default and said second measurement activity is switched to said active state when said radio conditions measured by said first measurement activity are detected.

41. The user equipment of claim 38, wherein said first measurement activity comprises radio link monitoring of at least a serving PSCell, said second measurement activity comprises measuring radio conditions of at least one target PCell and second measurement activity is switched to said active state when a radio link failure, T310 activation or beam failure associated with said serving PSCell is detected.

42. The user equipment of claim 38, wherein said instructions cause the user equipment at least to:
activate said second measurement activity when a radio link failure, T310 activation or beam failure associated with said serving PSCell is detected.

43. The user equipment of claim 33, wherein said user equipment is configured for dual connectivity with at least said network node comprising a source master node and with a first secondary node and said configuration message comprises a handover request acknowledgement received from said master node, said handover request acknowledgement indicating a first activity of applying a configuration for connection with a target master node and said first secondary node when an activated first condition of a radio link failure, T310 activation or beam failure associated with a serving PSCell is not detected and said handover request acknowledgement indicating a second activity of applying a configuration for connection with said target master node and a second secondary node when a deactivated second condition is activated, said deactivated second condition being activated when said first condition is false.

44. The user equipment of claim 43, wherein said instructions cause said user equipment at least to:
upon detection of said radio link failure, T310 activation or beam failure associated with said serving PSCell, activate said second condition.

45. The user equipment of claim 38, wherein said first measurement activity comprises measuring radio conditions of a currently serving cell and said second measurement activity comprises measuring radio conditions of a target serving cell, said first measurement activity is to be in said inactive state by default and said second measurement activity is to be in said active state by default, said second measurement activity is to be switched to said inactive state and said first measurement activity is to be switched to said active state when a cell change is executed from said currently serving cell to said target serving cell.

46. The user equipment of claim 45, wherein said instructions cause said user equipment at least to:
activate said first measurement activity and inactivate said second measurement activity when a cell change is executed from said currently serving cell to said target serving cell.

47. The user equipment of claim 33, wherein said user equipment is configured for dual connectivity with at least said network node comprising a source master node and with a source secondary node and said configuration message comprises an RRC Reconfiguration message received from said source master node, said RRC Reconfiguration message indicating a first activity of measuring a PSCell of said source secondary node with a first condition of said measuring being deactivated when said user equipment is connected to said source master node, said RRC Reconfiguration message indicating a second activity of measuring a PSCell of said target secondary node with a second condition of said measuring being activated when said user equipment is not connected to said target master node.

48. The user equipment of claim 47, wherein said user equipment is configured in response to executing conditional primary serving cell change towards said target secondary node to activate said first activity of measuring said PSCell of said source secondary node with and deactivate said second activity of measuring said PSCell of said target secondary node.

49. The user equipment of claim 47, wherein said measuring is deactivated by deactivating an associated measurement_ID and activated by activating an associated measurement_ID.

50. The user equipment of claim 38, wherein said first measurement activity comprises measuring radio conditions of a currently serving cell and said second measurement activity comprises measuring radio conditions of a target serving cell, said first measurement activity is in said active state by default and said second measurement activity is in said inactive state by default, said second measurement activity is switched to said active state when a degradation in said radio conditions measured by said first measurement activity beyond a threshold amount is detected.

51. The user equipment of claim 50, wherein said first measurement activity comprises measuring radio conditions of at least a serving PCell, said second measurement activity comprises measuring radio conditions of at least a PSCell and said measurement configuration message provides an indication of a further measurement activity comprising measuring radio conditions of at least a serving PCell and a further condition to be fulfilled prior to switching said second measurement activity to said active state.

52. The user equipment of claim 51, wherein said further condition comprises measuring a received signal power which is lower by an offset amount than the power measured by the first measurement activity which would lead to conditional handover.

53. The user equipment of claim 51, wherein said instructions cause the user equipment at least to:
activate said second measurement activity when said received signal power is lower by said offset amount than the power measured by the first measurement activity which would lead to conditional handover.

54. The user equipment of claim 33, wherein said user equipment is configured for dual connectivity with at least said network node comprising a source master node and with a first secondary node and said configuration message comprises a handover request acknowledgement received from said master node, said handover request acknowledgement indicating a first activity of applying a configuration for connection with a target master node when a first activated condition of measured radio conditions require a conditional handover, a deactivated second condition measuring radio conditions of a PSCell and an activated third condition of determining when measured radio conditions are a predetermined amount lower than those requiring a conditional handover, said second condition being activated when said third condition is true.

55. The user equipment of claim 43, wherein said instructions cause said user equipment at least to:
upon detection said third condition being true, activate said second condition.

56. The user equipment of claim 54, wherein said instructions cause said user equipment at least to:
upon detection said first condition being true, determine said PSCell addition associated with said second condition.

57. The user equipment of claim 33, wherein said instructions cause said user equipment at least to:
deactivate any measurement-ID that fails to meet its condition.

58. The user equipment of claim 33, wherein said instructions cause said user equipment at least to:
deactivate any measurement-object that is not linked to any active measurement-ID.

59. The user equipment of claim 33, wherein said instructions cause said user equipment at least to:
deactivate any measurement gap or Synchronization Signal Block-based Radio Resource Management Measurement Timing Configuration window which is not related to any active measurement-object.

60. A non-transitory computer readable medium comprising program instructions stored thereon for performing at least the following:
receiving a configuration message from a network node, said configuration message providing an indication of an activity to be performed by said user equipment together with a condition related to said activity, wherein said condition indicates when said activity is to be in an active state where said activity is to be performed by said user equipment connected to said network or in an inactive state where said measurement activity is not to be performed.

61. A network node for a telecommunications network comprising:
at least one processor; and
at least one memory storing instructions that, when executed by the at least one processor, cause the network node at least to:
transmit a configuration message to a user equipment, said configuration message providing an indication of an activity to be performed by said user equipment together with a condition related to said activity, wherein said condition indicates when said activity is to be in an active state where said activity is to be performed by said user equipment connected to said network or in an inactive state where said measurement activity is not to be performed.

62. A non-transitory computer readable medium comprising program instructions stored thereon for performing at least the following:
transmitting a configuration message to a user equipment, said configuration message providing an indication of an activity to be performed by said user equipment together with a condition related to said activity, wherein said condition indicates when said activity is to be in an active state where said activity is to be performed by said user equipment connected to said network or in an inactive state where said measurement activity is not to be performed.
